(19) United States
(12) Patent Application Publication
(10) Pub. No.: US 2008/0071815 A1
(43) Pub. Date: Mar. 20, 2008

(54) Revenue Sharing Based on Geographic Areas

(76) Inventors: Ian Eisenberg, Seattle, WA (US); Jeffrey Moore, Mercer Island, WA (US); James Andrew Shirey, Seattle, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/532,740

(22) Filed: Sep. 18, 2006

(51) Int. Cl. G06F 7/00

(52) U.S. Cl. 707/101

(57) ABSTRACT

SMS and telephony end users are associated with media outlets by mapping media outlets to geographic locations associated with telephone numbers, collecting telephone number information from responsive SMS and telephony end users, determining the resulting correspondence, and utilizing the resulting correspondence in furtherance of a business plan or contractual arrangement.

### TECHNICAL FIELD

The technical field of the invention relates generally to the areas of telecommunications, software, and computer equipment, and more particularly to associating telecommunications end users with geographic areas and with third parties found in such geographic areas.

### BACKGROUND

Advertisers and other content providers have incorporated telephony and short message service, or “SMS,” into their business models; in conjunction with the display or performance of the advertisement or content, a phone number is provided to call or an SMS short code is provided to message. In many advertising and content based business relationships, a media outlet (such as, and without limitation, a television or radio station, billboard company, university or other individual or organization which disseminates audio, visual, and tactile media to an audience) may be paid a share of the revenue, donations, or other consideration, collectively referred to herein as the “revenue,” which is received by the advertiser or content provider or by a third party from end users or as a result of end user action.

If a media campaign covers a large geographic area, a current practice is to employ different short codes, keywords, phone numbers to call or send keywords to, or similar in the advertisements or content disseminated by the different media outlets and to track which media outlets used or were assigned which short codes, keywords, phone numbers or similar. Responsive communications by end users may be traced to the advertisements and content disseminated by the different media outlets based on the short codes, keywords, phone numbers or similar which are used by or detected in the responsive communications from the end users. The resulting revenue share and/or fee owed to or earned by the media outlet may be determined thereby. The invention disclosed herein for sharing revenue with media outlet(s) has not previously been developed or employed.

### BRIEF SUMMARY OF THE INVENTION

The present invention is directed at sharing revenue with media outlets based on geographic criteria. In one embodiment, a media outlet is associated with one or more geographic identifier(s), such as a part of a phone number within the media outlet's coverage area. Revenue derived from responsive communication(s) which include the associated geographic identifier(s) is shared with the media outlet.

### BRIEF DESCRIPTION OF THE DRAWINGS

FIG. 1 is an exemplary network, device, and actor diagram in which systems and methods consistent with the principals of the invention may be implemented.

FIG. 2 is an exemplary diagram of a computer readable medium encoded with computer-executable components in and through which systems and methods consistent with the principals of the invention may be implemented.

FIG. 3 is a process flow chart of exemplary steps consistent with the principals of the invention.

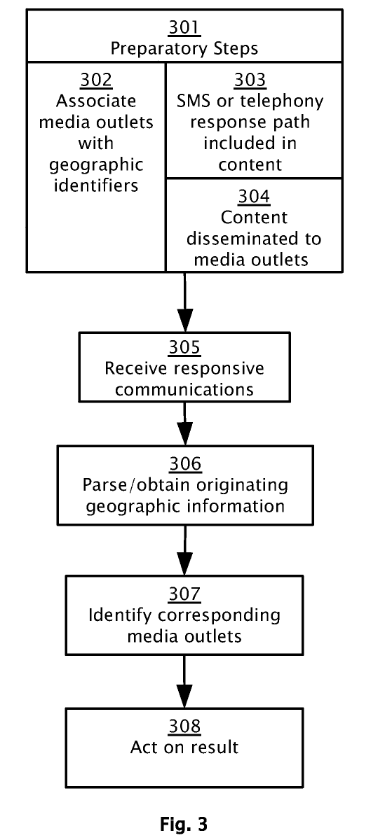

### DETAILED DESCRIPTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims.

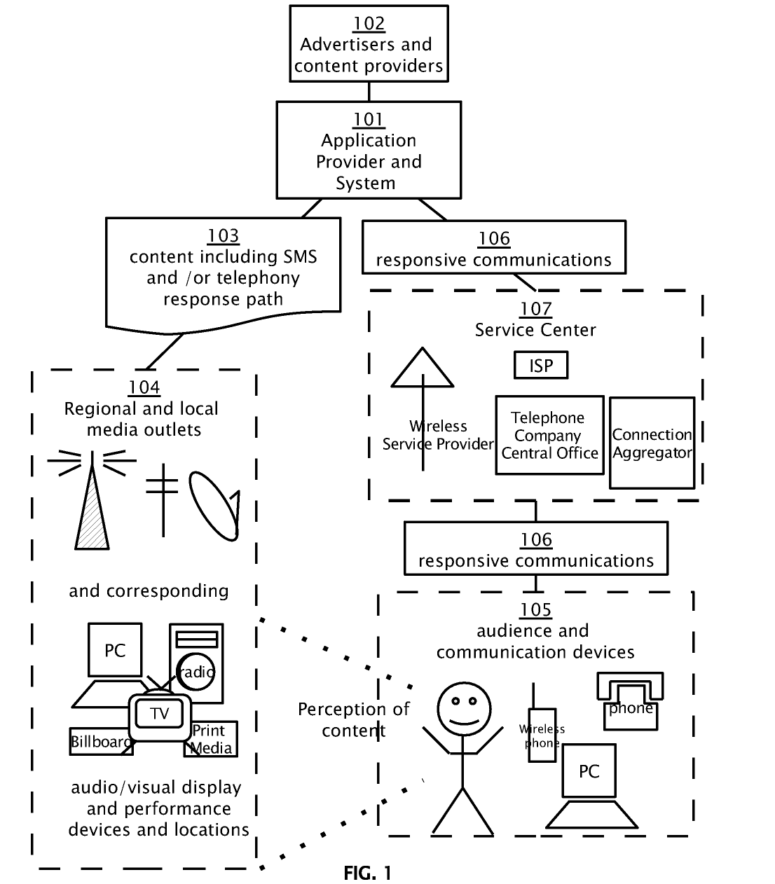

The application provider 101 may be an advertiser and/or content provider 102 or may receive advertisements and/or content, hereinafter referred to as “content,” from an advertiser and/or content provider 102. While depicted in FIG. 1 as separate entities, the application provider 101 and the content provider 102 may be the same or separate entities. The content 103 may comprise any audio, visual, or tactile media or combination thereof, whether digital, analogue, broadcast, web or Internet based, or delivered via physical media such as direct mailing or billboard. The content includes information that enables a consumer or audience member to take advantage of the advertised goods or services or to otherwise respond to the content. In one implementation, the content describes a good or service that can be acquired using an advertised SMS short code and a textual identifier or keyword. In another implementation, the content includes a telephone number that can be used to acquire the good or service.

If not already present in the content, the application provider 101 may embed an SMS short code and/or a telephone number into the content 103. The content including the SMS and/or telephony response path 103 is disseminated 304 to media outlets which display or perform the content 104. While depicted in the drawings as separate entities, the media outlets 104 may be the same entity as the application provider 101 and/or the content provider 102.

The media outlets 104 may be similarly diverse and may exist in a market composed of multiple regional and local layers which buy and sell content distribution and performance rights from one another. In one specific example, a media outlet 104 may be a local television station that broadcasts television programming over a given geographic area. In another example, the media outlet 104 may be a radio station that broadcasts radio programming over a given geographic area. Many other examples will be apparent to those skilled in the art.

In a typical application, an item of content is distributed via a media outlet 104 using any available distribution medium, including, without limitation, satellite communications systems, Internet delivery, delivery of computer-readable media, or delivery of printed articles or instructions for producing printed articles. In implementations where the media outlet 104 includes multiple layers, local media outlets may obtain the content from a national or regional media outlet and present or perform the content before the local media outlet's local audience. While such wide a distribution is by no means necessary, such a distribution highlights the ability to relate responsive communications (and optionally revenue as well) to the media outlets which made possible the final display or performance of the content before the audience (as described further below).

Prior to, contemporaneous with, or even after the acts of disseminating the content to media outlets 104 and presenting or performing the content before the audience, the application provider 101 associates media outlets 104 with geographic identifiers and corresponding geographic areas. In one specific example, each geographic identifier may correspond to an area code of a telephone number which, in turn, corresponds to the geographic area in which the area code is utilized. In another specific example, the geographic identifier may correspond to one or more area codes and exchange identifiers (described more fully below). The pairings of media outlets to geographic identifiers are stored in a media outlet database 202. Throughout this disclosure, the term “database” refers to any database, table, map, or other system implemented in a computer-readable medium encoded with computer executable components. The term media outlet database is used to represent a database of a geographic or logical area and one or more overlays or the location of one or more actors or objects within the geographic or logical area. Practitioners skilled in the art will appreciate that there are various ways to create a map, table, database or other system to represent a geographic or logical area and the overlap and/or degree of overlap between two or more overlays within the area.

Without limitation, media outlets 104 may be associated with geographic areas through the use of telephone numbers. More specifically, each geographic area is associated with a corresponding area code for a particular telephone number. The first six digits of a ten digit telephone number are often said to be the “NPA-NXX,” wherein the “NPA” stands for a “Number Plan Area,” which may be directly related to a specific geographic area, and the “NXX” or “network number exchange” being a number assigned to a specific service provider within an NPA. Thus, the geographic areas associated with phone numbers may be obtained from the NPA and, to a lesser extent, from the NXX (the NXX adding information in those cases in which it is known that a particular service provider within an NPA serves only a portion of the NPA). The geographic areas which correspond to the NPA-NXX within telephone numbers may be obtained from publicly and privately available sources. In other words, each media outlet 104 may be associated with a particular geographic area by creating an affiliation between a particular media outlet and an area code (or NPA-NXX pair), such as the area code in which the media outlet broadcasts its content. Again without limitation, each geographic area/media outlet pairing might then be assigned to a record in the media outlet database 202.

In one specific implementation, an area is divided into geographic units, each unit being assigned a row within a table (which might exist within or define a database or a portion of a database). A column may then be created in the table, with the resulting cells containing values to represent whether the geographic area of an NPA-NXX is found within a geographic unit. If the geographic units correspond exactly to the geographic areas defined by the NPA-NXX, the column entries could be a binary or Boolean value representing “on/true” or “off/false” or the rows could simply represent the NPA-NXX numbers. If the geographic units in the rows of the table are smaller than the geographic area associated with the NPA-NXX within a telephone phone number, then the overall percentage overlap between the geographic area defined by the NPA-NXX and the geographic units being represented by the number of cells containing a “true” or equivalent value. If the geographic units represent larger geographic areas than those associated with the NPA-NXX, then the column entries could be numerical values between zero and one, with zero representing no overlap between the geographic area of a particular NPA-NXX and the geographic unit, one representing complete overlap, and values between zero and one representing a percentage of overlap.

In another specific example, mobile telephone systems, including mobile voice over IP systems, in the role of a service center provider 107 identify the location of communication device(s) 105 which initiate responsive communication(s) 106. The identification of the location of communication device(s) 105 may include identification by geographic location (obtained, for example, through triangulation) and/or by identification of the base station(s) and/or the geographic location of the base station(s) communicating with the communication device 105 (hereinafter the “wireless location information”). As an additional overlay in the preceding example, a column in added in the table, which column corresponds to the wireless location information which may be available from mobile telephone systems. In this example, the resulting cells receive Boolean or numerical values to indicate overlap or a percentage of overlap with the geographic units represented in the rows in the table.

The geographic coverage area of one or more media outlets may be provided by the media outlet(s) and/or by third parties such as the Federal Communications Commission (the “FCC”), industry associations, or through field research. One or more columns may be created in the table for the one or more media outlets, the resulting cells being populated with values to represent whether the geographic coverage area of the one or more media outlets corresponds to one or more of the geographic units represented by the rows. As with the NPA-NXX numbers, the cell values may be binary or Boolean or numerical values between zero and one, depending on the relative size of the geographic coverage area(s) and the geographic units and whether it is desirable to represent Boolean correspondence or a more detailed percentage of overlap. The overlap between the geographic coverage area of the media outlets and the NPA-NXX geographic areas, the wireless location information, and the other geographic areas represented in the table, if any, may then be computed by compiling the values across or within each row in the table. The overlap may be computed periodically and made available for more rapid lookup or may be computed on an as-needed basis.

Practitioners skilled in the art will appreciate that the foregoing is merely an example and that there are various ways to create a map, table, database or other system to represent a geographic or logical area and the overlap and/or degree of overlap between two or more overlays within the area. In another example, and without limitation, the media outlet database 202 might include a table of identifiers for media outlets and the NPA-NXX numbers which correspond to the media outlets.

The media outlet database 202 would likely be updated from time to time and might be provided with means to do so.

After the content is disseminated to media outlets 304 and presented to or performed before the audience 104, one or more members of the audience use a communication device 105 to transmit a responsive communication 106. In this disclosure the expression “communication device” refers to any wireless or wireline analogue or digital phone, Smart phone, multimedia PC, website or other computer interface, voice over IP system, or other analogue or digital device or service which can send and/or receive voice calls and/or SMS message(s) and which uses a telephone number or a short code to, at least in part, route communications to and from the communication device or to identify the communication device.

The responsive communication 106 may be any form of telecommunication message that includes originator identification information based, at least in part, on a telephone number. Examples of the responsive communications 106 include SMS messages, MMS messages, telephone calls (VoIP or otherwise), e-mail messages, and the like. The responsive communications 106 may be transmitted over any available network and using any network communication protocol, such as and without limitation, SS7, GSM MAP, IS-41, TCP/IP, and similar.

The responsive communications 106 may be transmitted to an intermediate service center 107 which may process such responsive communications prior to forwarding or relaying the responsive communications 106 to the application provider 101 and/or the advertiser and/or content provider 102. The responsive communications 106 may also be received by the application provider 101 and/or the advertiser and/or content provider 102 directly in a peer-to-peer system. Examples of the intermediate service center 107 include wireless or wireline telecommunications service providers, and the like. The intermediate service center 107 may provide billing and validation services in relation to the responsive communications 106 and/or may act as a connection aggregator and/or may fulfill a relatively passive role in relaying the responsive communications 106 across or through the communications network. Billing services in relation to responsive communications may include billing for SMS, 800 or 900 number services, billing for access to ringtones, music, or other downloadable goods or services, in addition to billing for conventional telephony services.

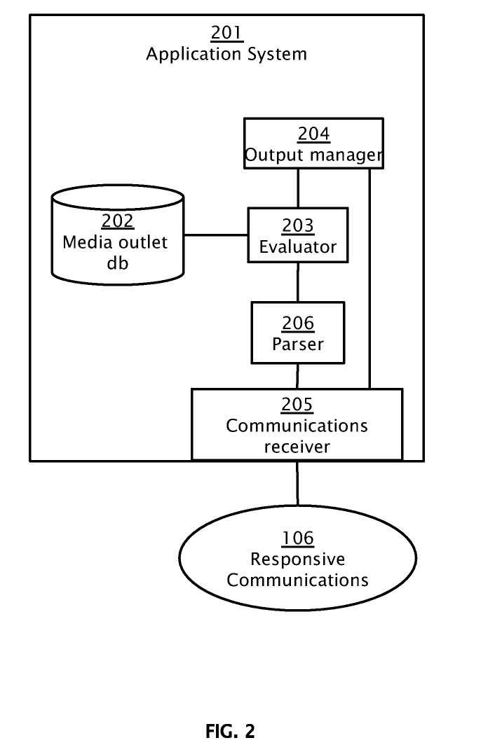

Referring again briefly to FIG. 2, the application system 201 receives the responsive communications 106 at a communications receiver 205. The communications receiver 205 and one or more of the other components of the application system 201 may be physically and/or logically separate from one another or may be physically and/or logically part of the same device or system, such as, for example and without limitation, if the application system 201 is provided by a telephony server. For example and without limitation, the application system 201 may be provided by one or more appropriately configured computers, including a distributed computer system, operating a telephony server application and which may include, without limitation, application specific computer hardware and software such as network interfaces, switch emulators, codec translators, and analogue to digital and digital to analogue converters. The application system components, individually, in any sub-combination, or together, may be provided remotely, including by a third party, as one or more services accessed via an API or similar.

Upon receipt of the responsive communications 106 at the communications receiver 205, the responsive communications are parsed 306 by a parser 206 to identify, at least, the telephone number(s) used to initiate the responsive communication(s) 106. In the case of responsive communications 106 from a system which provides wireless location information, the wireless location information may be part of the responsive communication 106 or may be obtained separately and may be associated therewith by the parser 206. In another example, the parser 206 obtains a home and/or billing address associated with the responsive communication 106. This information may be obtained from the service center 107, from a transaction record associated with the responsive communication 106, or from another source, such as a reverse phone number lookup table. The telephone numbers and/or wireless location information and/or location information identified by the parser 206 are evaluated by an evaluator 203 which accesses the media outlet database 202 to identify 307 if the telephone numbers and/or wireless location information and/or location information corresponds to one or more of the media outlets 104.

If a correspondence is identified 307 between the telephone number and/or wireless location information and/or location information associated with a responsive communication 106 and a media outlet 104, then the output manager 204 may act on the result 308 by, for example and without limitation, identifying the revenue received from or as a result of the responsive communication 106 and identifying that some portion of the revenue or some other amount (such as a fixed fee) should be paid to the media outlet 104. The output manager 204 may also transmit some or all of the responsive communication 106 to the advertiser and/or content provider 102, to third parties, or to other systems. In one specific example, the revenue may be realized as a result of billing services provided by the service center 107; this might be the case for responsive communications 106 utilizing SMS, responsive communications 106 utilizing a 900 number, or responsive communications 106 which result in purchase of a ringtone, music file, or the like (if the service center 107 is involved in selling ringtones, music, or similar). In another specific example, the responsive communications 106 result in revenue receipt by another party, such as an advertiser or content provider 102, which party reports the revenue to the application provider 101. Without limitation, revenue might be received from sale of a good or service, including download of a ringtone, music file, information source, or sale of an article of clothing or any other good or service; in another example, revenue might consist of a donation made by the audience member who initiated the responsive communication 106.

In another specific example, the media outlet 104 is the same as the application provider 101 and/or advertiser or content provider 102, in which case the resulting revenue is identified as stemming from content 103 disseminated by a geographically identifiable component of the media outlet 104. A payment might be made across divisions within the combined media outlet 104 application provider 101 and/or accounting or other records might be created to note the link between the revenue and the geographically identifiable component of the media outlet 104.

It will be appreciated that the embodiments described here are directed at a system wherein a revenue stream from a consumer is to be shared with a media outlet. Each media outlet is associated with a particular geographic area that corresponds to a portion of a telephone number, such as an area code and/or wireless location information. Revenue realized on messages that originated in the geographic area are shared with or otherwise identified as being related to the corresponding media outlet.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. A computer-readable medium encoded with computer-executable components, comprising
an electronic database which associates one or more first party(ies) and one or more geographic identifier(s), which geographic identifier(s) is or are related to or the same as one or more geographic area(s);
a communications receiver suitable to receive communication(s) originated by telecommunications equipment having an originating telephone number;
a parser which parses the received communications to identify originating geographic information;
an evaluator which utilizes the electronic database to identify matches, if any, between the originating geographic information and the geographic identifier(s) of the one or more first party(ies); and
an output manager which receives any matches identified by the evaluator and implements rules and/or instructions relating to the received communication(s) and the identified matches.

2. The system according to claim 1 wherein the one or more geographic identifier(s) associated with the one or more first party(ies) is a number derived from and/or is the same as a telephone number.

3. The system according to claim 1 wherein the originating geographic information includes an originating telephone number.

4. The system according to claim 1 wherein the originating geographic information includes wireless location information.

5. The system according to claim 1 wherein the originating geographic information includes a home and/or billing address.

6. The system according to claim 1, wherein a rule and/or instruction implemented by the output manager comprises determining an amount of a donation, payment, or other form of consideration associated with the received communication(s).

7. The system according to claim 1 wherein at least one of the one or more first party(ies) is a media outlet.

8. The system according to claim 2, wherein the number derived from the telephone number is an area code.

9. The system according to claim 5 wherein the home and/or billing address is obtained from a service provider's records or an information source such as a reverse phone number lookup.

10. The system according to claim 6, wherein the donation, payment, or other form of consideration comprises a portion of revenue derived from the received communication(s).

11. The system according to claim 6 wherein a rule and/or instruction implemented by the output manager comprises producing a record which reflects an obligation to make or have made a payment to at least one of the one or more first party(ies).

12. A method comprising the following steps, not necessarily in the following order,
associating at least one or more first party(ies) with one or more geographic identifier(s);
preparing or having prepared and disseminating or having disseminated content which content includes at least one SMS short code and/or telephone number;
receiving one or more responsive communications directed to the disseminated SMS short code(s) and/or telephone number(s);
parsing the one or more responsive communications to determine originating geographic information associated with the responsive communication(s);
identifying at least one of the one or more first party(ies) by comparing the originating geographic information with the geographic identifier(s) of such first party(ies); and
following rules and/or instructions related to the result of such identification.

13. The method according to claim 12, wherein the one or more geographic identifier(s) associated with the one or more first party(ies) is a number derived from and/or is the same as a telephone number.

14. The method according to claim 12, wherein the number derived from the telephone number is an area code.

15. The method according to claim 12, wherein the originating geographic information includes a telephone number.

16. The method according to claim 12, wherein the originating geographic information includes wireless location information.

17. The method according to claim 12, wherein the originating geographic information includes a home and/or billing address.

18. The method according to claim 12, wherein the rules and/or instructions comprise determining an amount of a donation, payment, or other form of consideration associated with the responsive communication(s).

19. The method according to claim 12, wherein the rules and/or instructions comprise producing a record which record reflects an obligation to make or have made a payment to at least one of the one or more first party(ies).

20. The method according to claim 12, wherein at least one of the one or more first party(ies) is a media outlet.

21. The method according to claim 17 wherein the home and/or billing address is obtained from a service provider's records or an information source such as a reverse phone number lookup.
